(19) United States
(12) Patent Application Publication
(10) Pub. No.: US 2021/0069998 A1
(43) Pub. Date: Mar. 11, 2021

(54) METHOD FOR COMPRESSION MOLDING OF ANISOTROPIC COMPONENTS

(71) Applicant: Arris Composites Inc., Berkeley, CA (US)

(72) Inventors: Ethan ESCOWITZ, Berkeley, CA (US); J. Scott PERKINS, Oakland, CA (US); Riley REESE, Oakland, CA (US); Yang SHEN, El Cerrito, CA (US); Erick DAVIDSON, Piedmont, CA (US)

(21) Appl. No.: 17/017,172

(22) Filed: Sep. 10, 2020

Related U.S. Application Data
(60) Provisional application No. 62/898,085, filed on Sep. 10, 2019.

(51) Int. Cl. B29C 70/54; B29C 70/34

(52) U.S. Cl. CPC B29C 70/54; B29C 70/34

(57) ABSTRACT

A system and methods are disclosed for producing compression-molded components having one or more desired characteristics with respect to one or more objectives. In accordance with one embodiment, a parameter space comprising a set of values of a parameter is defined, where the parameter corresponds to a property of fiber bundles, and where the set of values represents all possible values of the parameter in the parameter space. The parameter space is narrowed, and a statistical model is generated based on a sampling of the narrowed parameter space. A value of the parameter is selected based on the statistical model, and a bundle of fibers conforming to the selected value is produced. A component comprising the bundle of fibers is then manufactured using a compression-molding process.

### STATEMENT OF RELATED APPLICATIONS

The present application claims priority to, and incorporates fully by reference, U.S. Provisional Patent Application No. 62/898,085 filed Sep. 10, 2019.

### FIELD OF THE INVENTION

The present disclosure relates to compression molding.

### BACKGROUND

In compression molding, material is loaded into a mold, and a molding apparatus applies heat and pressure to form a molded component. The material may comprise one or more “preforms,” each of which is a sized and shaped portion of a bundle of fibers. Once the applied heat has increased the material's temperature above its melt temperature, the material is no longer solid and conforms to the mold geometry via the applied pressure. The material is held above its melt temperature at full consolidation for a short period of time known as the “soak” phase, and heat is then removed from the mold until the material has adequately cooled. The material is fully consolidated at this point and is pressed into the shape of a component corresponding to the mold. Having attained its final geometry, the finished component is ejected from the mold and is ready for use.

### BRIEF DESCRIPTION OF THE DRAWINGS

FIG. 1 depicts a first example of a component to be manufactured via compression molding, in accordance with one embodiment of the present disclosure.

FIG. 2 depicts the X-shaped component 100 shown in FIG. 1 with a first example of a preform charge for manufacturing the component, in accordance with one embodiment of the present disclosure.

FIG. 3 depicts component 100 with a second example of a preform charge for manufacturing the component, in accordance with one embodiment of the present disclosure.

FIG. 4 depicts a detailed view of the layup stack shown in FIG. 3, in accordance with one embodiment of the present disclosure.

FIG. 5 depicts a second example of a component to be manufactured via compression molding, in accordance with one embodiment of the present disclosure.

FIG. 6 depicts the example component 500 shown in FIG. 5 with an example of a preform assemblage for manufacturing the component, in accordance with one embodiment of the present disclosure.

FIG. 7 depicts an alternative view of the component 500 and preform assemblage depicted in FIG. 6, in accordance with one embodiment of the present disclosure.

FIG. 8 depicts component 500 with an alternative preform assemblage, in accordance with one embodiment of the present disclosure.

FIGS. 9A, 9B, and 9C depict a flow diagram of aspects of a method for determining input parameter values for the production of a compression-molded component, in accordance with one embodiment of the present disclosure.

FIG. 10 depicts a flow diagram of aspects of a method for narrowing a parameter space to be used for generating a statistical model, in accordance with one embodiment of the present disclosure.

FIG. 11 depicts a block diagram of an illustrative computer system operating in accordance with aspects and implementations of the present disclosure.

### DETAILED DESCRIPTION

When designing a component that will be created using a given manufacturing process, a model that relates inputs to outputs may be used to determine values of various input parameters that result in desired values of output characteristics of the manufactured component. In some examples, input parameters might include material properties such as stiffness, density, thermal stability, etc.; and/or preform properties such as shape (e.g., preforms having straight fibers through the intersection, preforms having bent fibers around a corner, etc.), orientation, etc.; and/or process parameters such as temperature trend, pressure trend, etc. Similarly, output characteristics might include stress, strain, strain energy, strength-to-weight ratio, stiffness-to-weight ratio, displacements, etc.

Manufacturing process models that relate inputs to outputs in a deterministic fashion are desirable because they enable the selection of input parameter values based on desired (ideally optimal) output characteristics of a component prior to physical manifestation. Injection molding, for example, is a manufacturing process for which a deterministic model can be constructed, because a finite element analysis (FEA) approach is possible.

Compression molding, in contrast, is a manufacturing process whose dynamics are difficult to model deterministically (for example, the process dynamics are non-linear). In special cases however (e.g., simple geometries, simple materials, both simple geometries and simple materials, etc.), the input parameter space (i.e., the ranges of possible input values for all of the input parameters) may be sufficiently small to allow the construction and use of a deterministic model. Accordingly, as long as there is an adequate volume and mass of material in simple structures, the application of heat and pressure results in the material successfully filling the mold cavity, independent of the material's initial orientation and placement.

For example, in the case of laminate/sheet structures, which have a planar geometry and relatively simple fiber alignment, composite laminate theory can be applied, which results in a modest input parameter space—namely, the quantity, angles, thicknesses, and materials of constituent laminate plies. This allows the use of finite element analysis (FEA) methods to obtain a deterministic model defining the structure's performance relative to the values of the input parameters. In particular, compression molding of laminate/sheet structures in the prior art is characterized either by short fibers that are displaced during cavity filling, or long fibers within a laminate that remain largely in place. For example, the short fibers present in bulk molded compounds (BMC) do not inhibit displacement, while the long fibers within a laminate undergo negligible displacement.

In some other types of composite structures for which the parameter space may be large, it may still be possible to obtain a deterministic model. For example, in some other types of structures, such as non-laminate/sheet chopped-fiber structures, fiber alignment may not be an issue. Similarly, in matrix structures there may be interdependent relationships between parameters, effectively reducing the size of the parameter space.

The situation is different, however, for components that have complex composite structures (e.g., components having non-sheet based geometry, components having long fibers that require complex alignments dictated by preform features, etc.). In addition to having large input parameter spaces, these components may be difficult to characterize, which precludes the use of finite element analysis (FEA) methods. It is therefore extremely difficult, and potentially intractable, to construct a deterministic model characterizing compression molding of complex components, or conduct high-throughput experimentation. As a result, approaches in the prior art for modeling compression molding of complex composite structures have been incapable of relating process inputs to desired characteristics of the manufactured component.

The complexity can increase further, and often dramatically, when an assemblage of multiple preforms, which we refer to as a “preform charge,” is used for compression molding a component. In some embodiments, the preform charge may be formed by tacking together plural preforms, while in some other embodiments, the preform charge may be formed by heating the plural preforms sufficiently to bond them where adjacent preforms meet, while in still other embodiments, the preforms may be pressed together with enough force to cause them to stick to one another. The preform charge effectively acts as a single unit, in which the preforms maintain their position relative to one another.

When using a preform charge, the particular arrangement of the constituent preforms is unique for any given component, and is highly consequential to the characteristics of the finalized component. The unique form factor of preform charges relative to the prior art of composite laminates can be significantly more complex, in terms of both the compression molding process and the size of the input parameter space. For example, input parameters related to the preform charge might include layup sequence (e.g., preform stack pattern, etc.), one or more ratios among constituent preforms (e.g. the ratio of bent to straight preforms, etc.), etc.

In addition, certain volumetric regions of components manufactured via compression molding of preform charges benefit from having highly-aligned continuous fibers (i.e., anisotropy), while others benefit from fibers oriented in numerous directions (i.e., quasi-isotropy). For example, long, continuous, aligned fibers in preform charges are capable of local feature-dependent displacement as well as global vertical displacement during compression. Design of a preform charge and its constituent preforms may therefore be performed with the intent of achieving desired fiber alignments in various volumetric regions. However, the uncertainty inherent in consolidation dynamics during compression molding may limit the effectiveness of the design.

In some examples, a preform charge may be three-dimensional, in which case the downward linear motion of the compression mold consolidates the vertical height to the final dimensions of the component. This consolidation exhibits significantly more nuance than that of individual preforms of the prior art, largely due to two differences with respect to the prior art: fiber length, and preform-charge stack height.

In some such instances, the form factor of constituent preforms within the preform charge may result in a vertical height that far exceeds that of preforms of the prior art, due to void spaces resulting from overlapping preforms. This vertical consolidation is governed by constrained fluid dynamics, as the melting of the constituent resin via applied heat causes it to conform to applied pressure. In addition, vertical consolidation of a preform charge is a result of the associated inputs of its parameter space. For example, the sequence in which constituent preforms are stacked in a preform charge may determine void spaces, and therefore how consolidation into these spaces proceeds. Accordingly, controlling vertical consolidation to achieve desirable results requires a thorough understanding of the fluid dynamics of consolidation, the physics of compression molding, and the parameter space of the preform charge. This level of understanding is formidable, and typically beyond the capability of most engineers and scientists skilled in the art.

Compression molding using preform charges may further require purposeful orientation and placement. Given the design latitude for preform charges (e.g., shape, size, stack sequence, etc.), the input parameter space defining all possible preform charge embodiments for a given component can be enormous, even when compared to the input parameter spaces of complex individual preforms, which are already large compared to simpler individual preforms of the prior art.

For the many reasons noted above, deterministically modeling compression molding with preform charges, and/or conducting high-throughput experimentation with preform charges, is prohibitive.

Embodiments of the present disclosure are directed to the design of components to be manufactured by compression molding, and in particular, embodiments of the present disclosure can be used to design compression-molded components having complex geometries and/or complex materials, such as fiber-reinforced polymers (FRPs) having long fibers, as well as other types of anisotropic materials (i.e., materials whose physical properties change with direction). Some aspects of the embodiments are based on unexpected empirical results encountered by the inventors during experimentation. In one such aspect, the inventors observed that during compression molding of preform charges, the displacement flow of fibers can be controlled by preform size and position within a preform charge to either inhibit or promote flow as desired. In another aspect, the inventors observed uncertainty resulting from the non-linear nature of fluid dynamics, and the non-intuitive nature of the constraining effect of long fiber on fluid dynamics. These observed phenomena are inherent to the compression-molding process, but are exceedingly difficult to model deterministically. In addition, the size of the associated parameter space is not well-suited to determining global optima via high-throughput experimentation.

Given the infeasibility of deterministically modeling compression molding of complex components, as well as the uncertainties of the compression molding process discovered by the inventors, embodiments of the present disclosure employ a statistical model. A statistical model is a set of one or more statistical assumptions that enable the calculation of outcome probabilities. In accordance with embodiments of the present disclosure, an outcome is a set of values for parameters in the parameter space.

In one embodiment, the input parameter space is randomly sampled in an automated fashion, enabling the development of a dataset from which the statistical model can be derived. The statistical model is then used to purposefully dictate the automated production of further samples until desired output characteristics for the component (ideally optimal) are attained. Embodiments of the present disclosure are thus capable of producing components with desired characteristics even with parameter spaces that would otherwise be prohibitively large.

In some embodiments, one or more objectives for a given component (e.g., maximize strength, maximize specific strength, maximize stiffness, maximize specific stiffness, maximize thermal stability, maximize impact resistance, minimize cost [e.g., use cheaper materials in regions having lower performance, etc.], maximize radio-frequency transparency, maximize surface finish aesthetic quality and/or consistency, etc.) are specified, and relevant features, aspects, and ranges of the parameter space having an effect on the objective(s) are identified. A goal of the identification process is to narrow the input parameter space (for example, reducing an input parameter space from, say, hundreds of thousands of possible input combinations to a few thousand possible input combinations). Ideally, the narrowing of the parameter space will provide a logical scope of the parameter space within which to experiment and model by excluding regions that will clearly lead to undesirable results (and may therefore be considered irrelevant to the desired statistical model), while retaining regions that have the potential to achieve desired results.

In some implementations, the identification process may be performed using approximated finite-element methods. Such finite-element methods are not necessarily representative of reality, but may be sufficiently close to enable the identification of possibly-relevant features. In some such implementations, one or more persons skilled in the art may participate in the identification process using their engineering knowledge, while in some other implementations, the identification process may be performed by persons skilled in the art without the use of finite-element methods.

In accordance with some embodiments, an initial condition is defined, and the narrowed parameter space is randomly sampled, beginning with the initial condition, to select input combinations of processing parameters (e.g., preform shape, preform-charge layup sequence, pressure trend, etc.). This random sampling represents a further narrowed set of experimentation data within the parameter space that can be used to guide automated manufacture of various possible manifestations of the desired component. In some implementations, the size of this smaller randomly-sampled subset may be determined by estimating the amount of data required to develop a representative statistical model of the initially-narrowed parameter space. This estimate may be based on measures such as the number of features to test, the ranges of the features to test, etc.

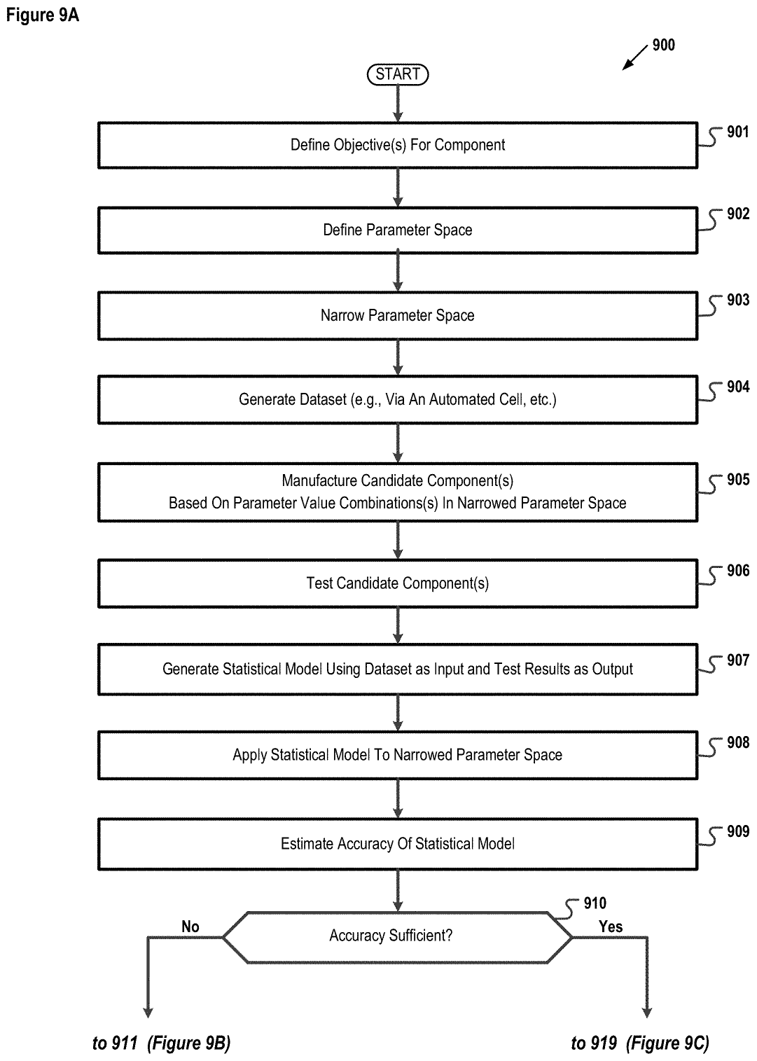

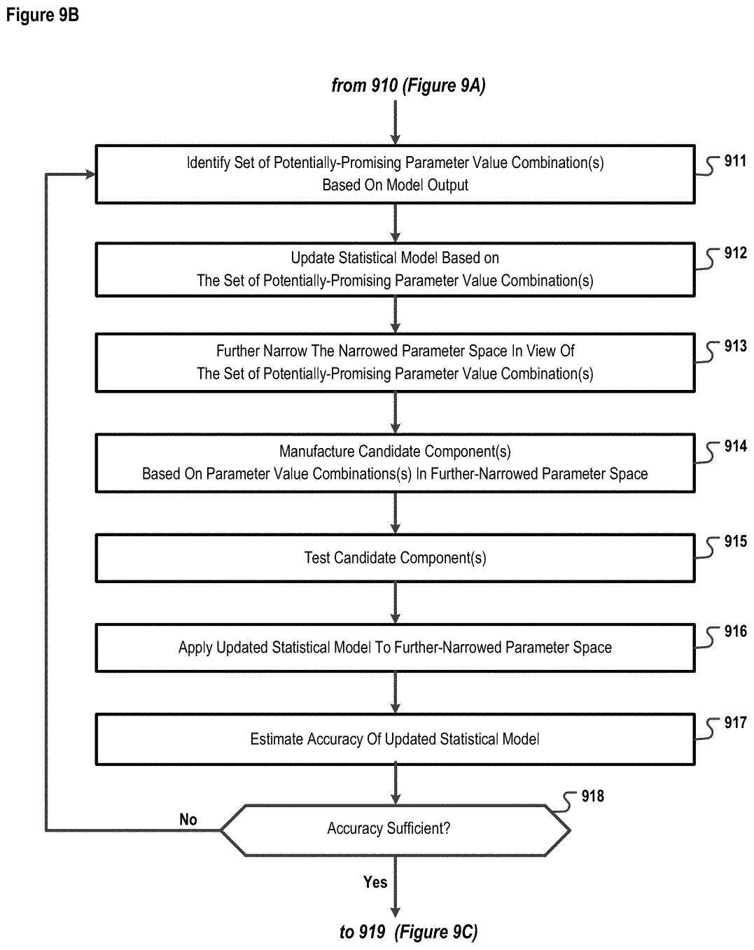

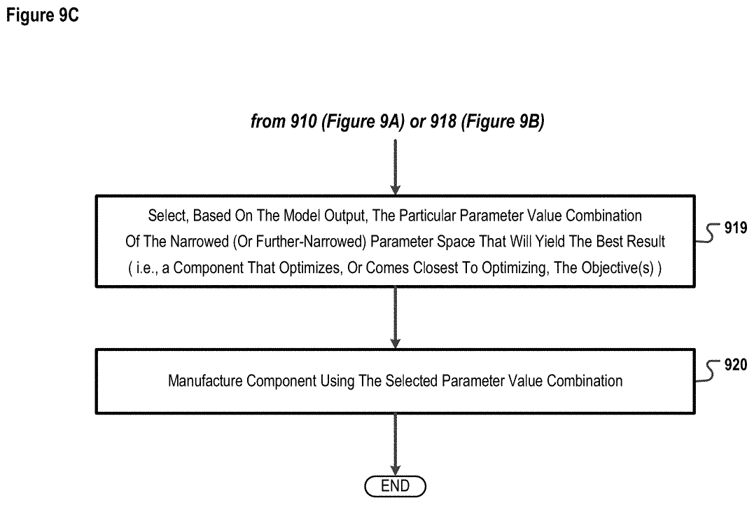

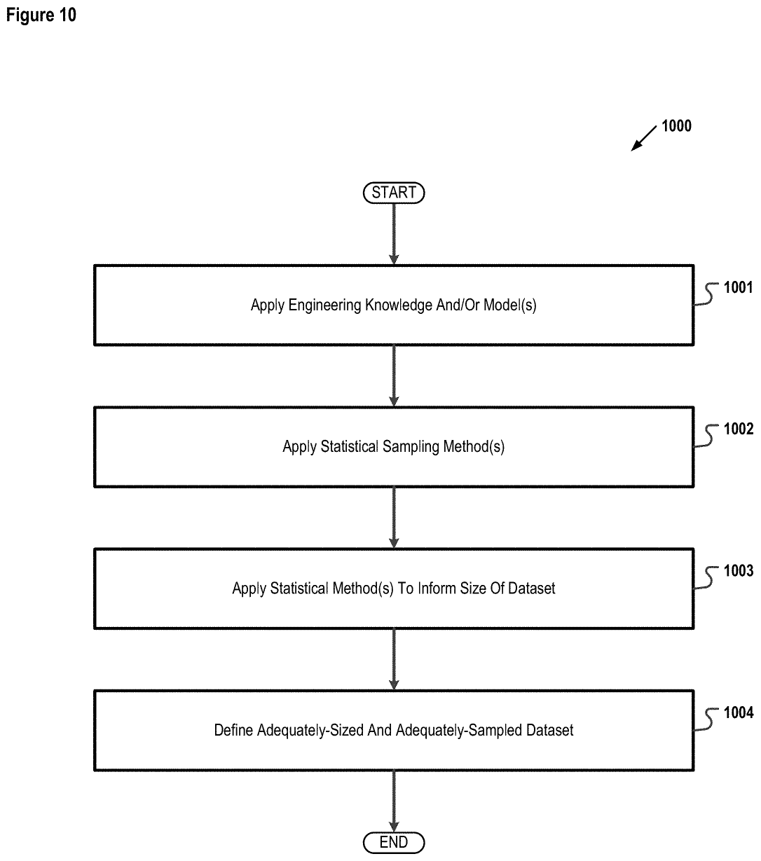

In some embodiments, automated production of samples as defined by the various input combinations may be complemented by automated testing of the objective quality of samples (e.g., stiffness, thermal stability, etc.). The automated production and testing processes may be performed by hardware (e.g., one or more sensors, etc.) and/or software (e.g., code embedded in a programming logic controller, etc.) capable of generating a dataset in which individual input parameter combinations are associated with corresponding output test data. The resultant dataset can then be used to develop a statistical model, as is described in detail with respect to the methods of FIGS. 9 and 10 below.

By physically manufacturing and testing samples, the dataset can potentially capture uncertainties introduced by the process (e.g., preform-charge consolidation dynamics during compression, etc.) that are difficult, if not impossible, to capture deterministically using methods of the prior art. The statistical model derived from the dataset may therefore have predictive capability of phenomena that were previously thought in the prior art to be unpredictable.

In accordance with one embodiment, the predictive capability of the statistical model is utilized to define combinations of input parameter values that are likely to produce desirable and/or interesting results with respect to the given objective for the final component. These input combinations are subsequently iterated through the automated manufacturing and testing setup to obtain output results. The actual output results can be compared to the predicted results to assess the model's accuracy, and if the model is not sufficiently accurate, it can be refined further. When the model has reached an acceptable level of accuracy, the finalized model can be used to predict, generate, and validate a set of one or more input parameter values that result in a component having desired (ideally optimal) output characteristics with respect to one or more specified objective(s) (e.g., maximizing stiffness in a particular region of the component, etc.).

As described in detail below, embodiments of the invention are well-suited to determining an optimal arrangement of flow preforms (i.e., preforms that flow when heat and pressure are applied). In particular, when molds with void spaces are used in the compression molding process, the manner in which material flows into the void spaces is inherently uncertain due to governing fluid dynamics. Accordingly, output characteristics of interest (e.g., strength, stiffness, thermal stability, etc.) can be associated with various arrangements of the flow preforms via statistical modeling, thus obviating the need to deterministically model the particular process employed.

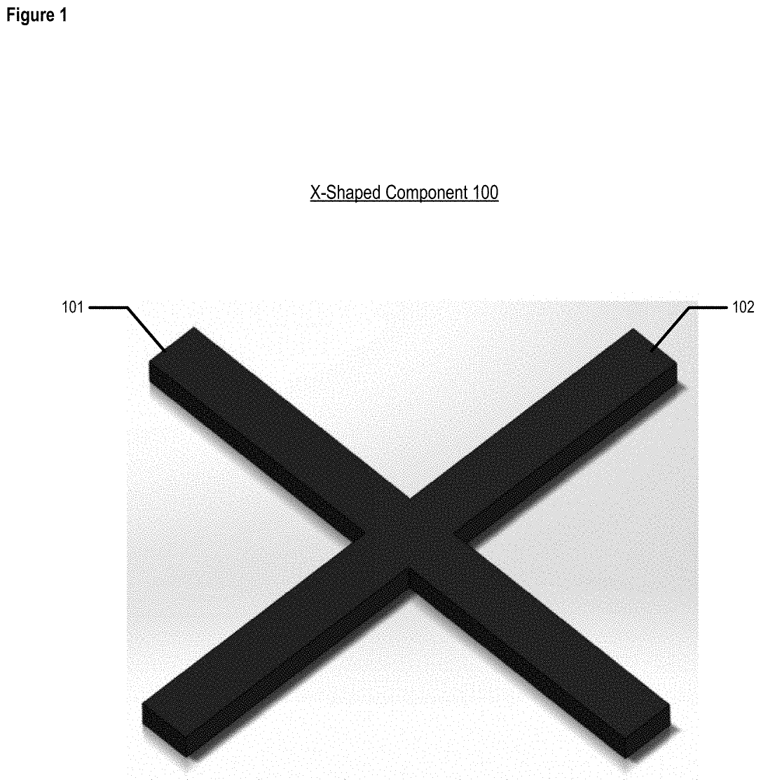

FIG. 1 depicts a first example of a component to be manufactured via compression molding, in accordance with one embodiment of the present disclosure. As shown in FIG. 1, the component 100 is X-shaped and has a first linear segment 101 that descends from left to right, and a second linear segment 102 that descends from right to left. In this example an objective for component 100 is sufficient stiffness in the central intersection region (i.e., a stiffness that meets or exceeds a particular threshold).

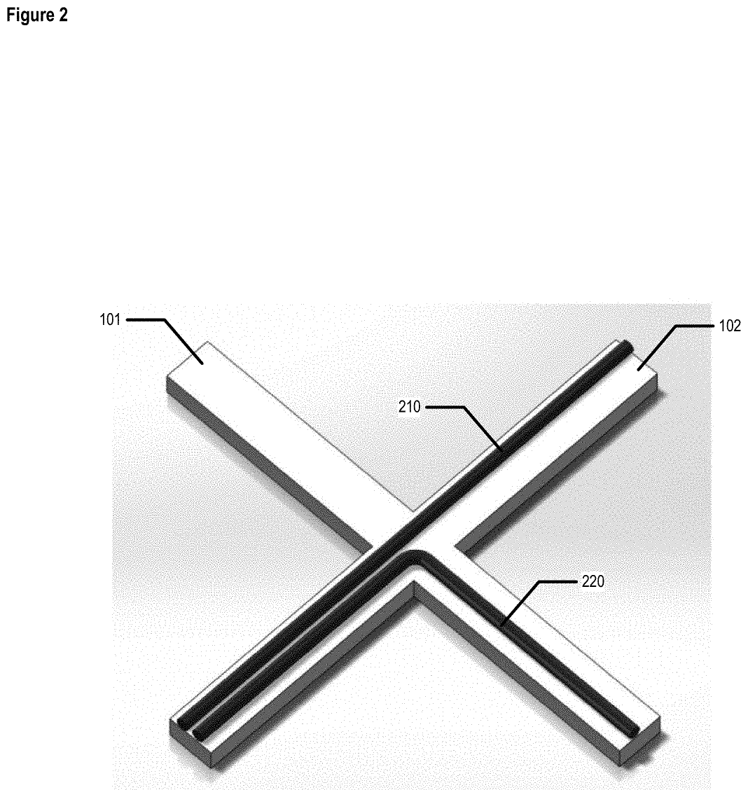

FIG. 2 depicts the X-shaped component 100 shown in FIG. 1 with a first example of a preform charge for manufacturing the component, in accordance with one embodiment of the present disclosure. In this example, two preforms 210 and 220 are situated above component 100. During the compression molding process, these preforms are compressed downward via applied heat and pressure.

As noted above, preform charges may comprise any combination of straight and bent preforms. In this example, preform 210 is straight and preform 220 is bent. The input parameter space for a preform charge may include parameters for the individual constituent preforms, such as shape (e.g., preforms having straight fibers through the intersection, bent fibers around a corner, etc.), orientation, etc., as well as parameters pertaining to the preform charge as a whole, such as one or more ratios among constituent preforms (e.g. the ratio of bent to straight preforms, etc.), layup sequence (e.g., preform stack pattern, etc.), and so forth. In the example of FIG. 2, the parameter values specify that:
there are two preforms in the charge;
preform 210 is straight;
preform 220 is bent;
preform 220 has one bend, dividing the preform into two sections;
the bend is 90 degrees;
preform 210 has length L, where L equals the length of the linear segments 101 and 102 making up component 100;
preform 220 has length L;
each of the two sections of preform 220 has length L/2;
preform 210 is situated on top of linear segment 102;
preform 220 is situated on top of linear segments 101 and 102;
preform 210 is aligned in the X-Y plane with one of the long edges of linear segment 102;
one section of preform 220 is aligned in the X-Y plane midway between the two long edges of linear segment 102, and the other section is aligned in the X-Y plane midway between the two long edges of linear segment 101;
the ratio of bent to straight preforms is 1:1.

It should be noted that while the above example specifies single exact values for each of the parameters (e.g., a 90-degree bend, a length L, etc.), in some other examples one or more parameter values may be specified by a range, rather than a single exact value (e.g., the bend of preform 220 might be in the range 87-93°, the length of preform 210 might be L+/−2 mm, the length of preform 220 might also be L+/−2 mm [which might or might not be exactly equal to the length of preform 210], etc.). Similarly, parameters associated with properties such as shape and orientation may comprise one or more ranges (e.g., respective ranges for the lengths of one or more sides of a polygon, respective ranges for one or more angles, etc.).

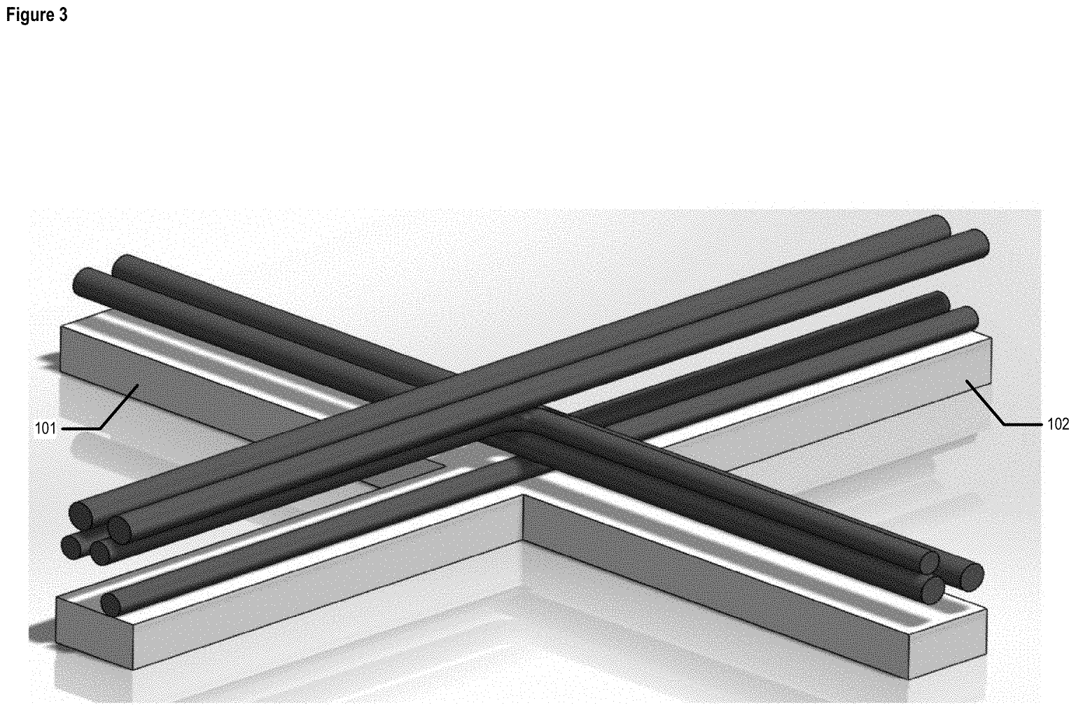

FIG. 3 depicts component 100 and a second example of a preform charge for manufacturing the component, in accordance with one embodiment of the present disclosure. In this example, all of the preforms are straight and have the same length—namely, length L (or have the same range about L). Given these geometrical constraints, the preforms cannot occupy the same horizontal plane, and thus the preforms must be stacked (in “layup stacks”), with each preform crossing the intersection of the X in alignment with one of the two linear segments of the part volume. As successive preforms are added to the preform charge, the vertical height of the layup stack increases due to the thickness of the preforms.

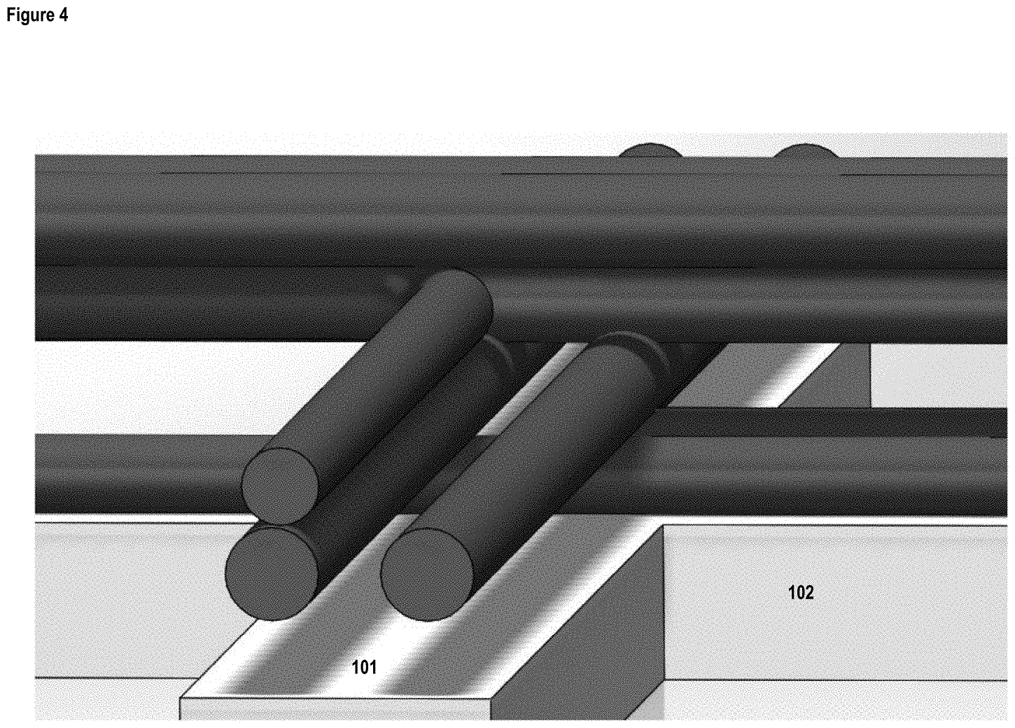

FIG. 4 depicts a detailed view of the layup stack of FIG. 3, in accordance with one embodiment of the present disclosure. As shown in FIG. 4, the sequence and orientation of preforms in the layup stack determine how the preforms overlap. The layup stack of FIG. 4 is merely illustrative; the preform charge can be stacked in any sequence and orientation, and can comprise any number of preforms provided that there is an adequate volume of material. As successive planes of preforms are added to the preform charge, the vertical height of the layup stack increases due to the thicknesses of the preforms. It should be noted that in some examples, all of the preforms may have the same thickness, while in some other examples the thickness of the performs may vary.

The overlapping of the preforms creates void spaces, the number and arrangement of which are based on the particular stack pattern. As heat and pressure are applied during the compression molding process, the void spaces will create respective pressure gradients. These gradients affect how material flows into the void spaces, and therefore the consolidation fluid dynamics, in accordance with the physics governing the filling of the void spaces with viscous fluid.

As noted above, one objective for the X-component in this example is sufficient stiffness of the central intersection region. The stiffness is determined by the fiber orientation after the compression-molding cycle has completed, and is therefore a result of the associated fluid dynamic consolidation of the initial preform charge.

As was the case for the first example preform charge of FIG. 2, the input parameter space for the present example preform charge of FIG. 3 may include parameters for the individual constituent preforms such as shape, orientation, etc., as well as parameters pertaining to the preform charge as a whole (e.g., layup sequence of the constituent preforms, one or more ratios among the constituent preforms, etc.). The parameter values for the present preform charge specify: the number of preforms; that all of the preforms are straight, with length L (perhaps in a range L+/−n mm, as noted above); the locations, orientations and alignments of the preforms; the vertical stacking sequence of the preforms; etc.

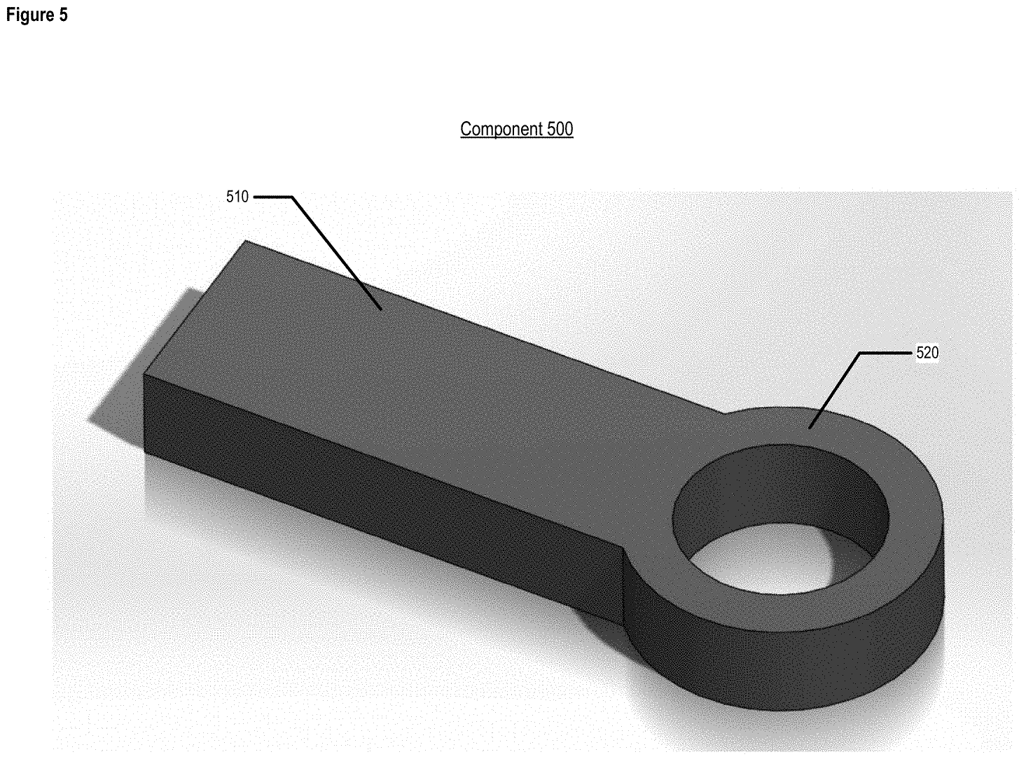

FIG. 5 depicts a second example of a component to be manufactured via compression molding, in accordance with one embodiment of the present disclosure. In this example, an objective for the component is to maximize strength.

As shown in FIG. 5, the component 500 comprises a volumetric region in which an annulus region 520 composed of flowed fibers is joined to a prismatic region 510. The annulus region 520 geometrically restricts direct placement of preforms, and thus preforms that are placed in a mold to produce component 500 will be placed in the mold region corresponding to prismatic region 510. In accordance with this example, the desired loading condition for producing component 500 is to constrain prismatic region 510 while pulling annulus region 520 in tension (using, for example, an appropriately-sized clevis pin) along an axis parallel to the major axis of prismatic region 510. It should be noted that in some instances, prismatic region 510 and annulus region 520 may have similar, or possibly equal, thicknesses, while in some other instances prismatic region 510 and annulus region 520 may have different thicknesses.

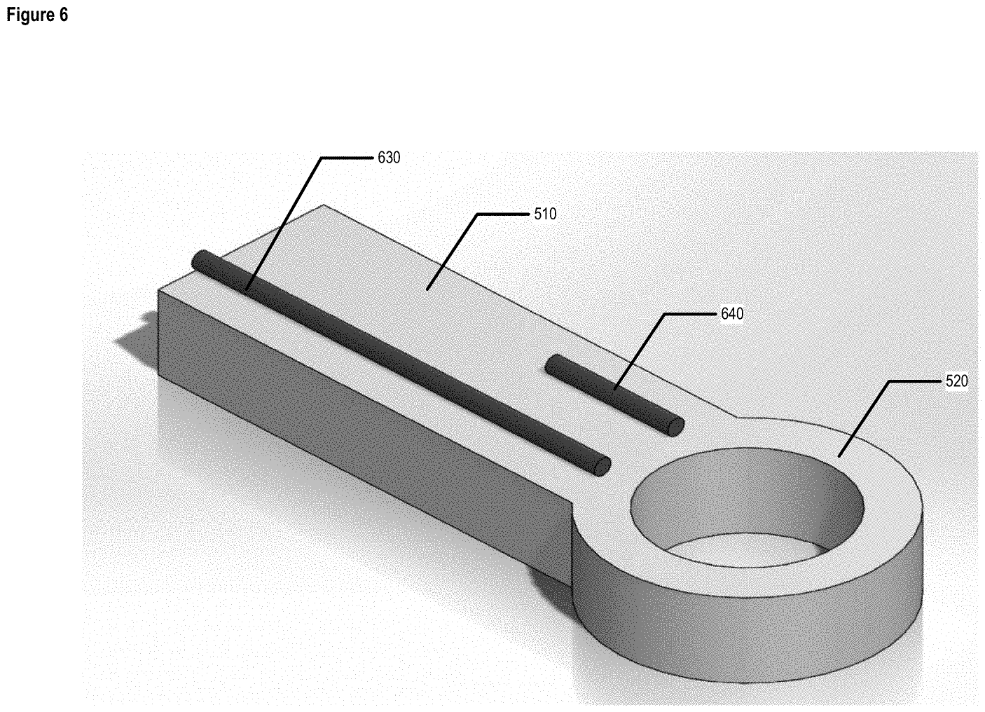

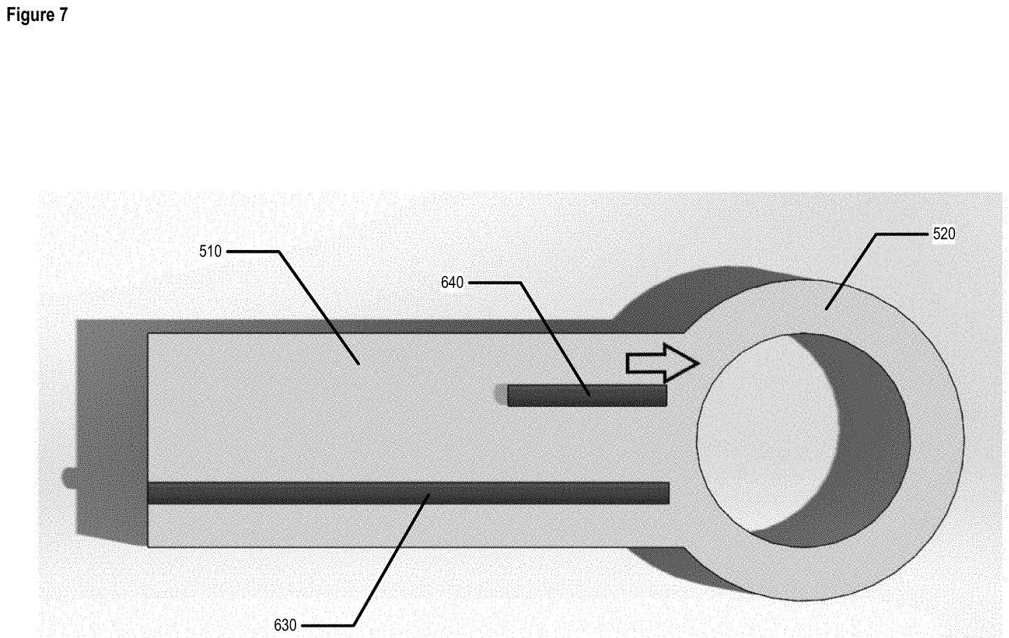

FIG. 6 depicts example component 500 and an example preform charge for manufacturing the component, in accordance with one embodiment of the present disclosure. As shown in FIG. 6, the preform charge consists of two preforms 630 and 640, each having unidirectional fiber alignment, that are straight segments situated proximally to annulus region 520. A top view is shown in FIG. 7.

When heat and pressure are applied during the compression molding process, the void space of the annulus region cavity results in a pressure gradient, causing material that is proximal to the cavity to flow into it. Accordingly, the preforms have been purposefully positioned relative to the prismatic region 510 into which they are to be amalgamated, so that they will flow into the cavity. In this particular example, the shorter preform 640 preferentially flows into the cavity while the longer preform 630 does not; this is due to the higher shear forces constraining the longer preform 630 relative to the lesser forces experienced by the shorter preform 640. Such fluid shear stress on fibers is one of many relevant physical dynamics during compression molding that are difficult, if not impossible, to model accurately.

The flow of shorter preform 640 into annulus region 520 is governed by input parameter values characterizing this preform, as well as the processing of these values and associated fluid dynamics. The flow determines the resultant fiber orientation within the annulus region 520, which in turn affects the strength of the annulus region. As noted above, maximizing overall strength is an objective for component 500. Therefore, fiber orientation in the annulus region 520 is a parameter to be optimized. Other parameters in the parameter space for this example include the physical dimensions of each preform (e.g., length, cross section diameter, etc.).

It should be noted that the preform charge in this example, comprising a single preform flowing into annulus region 520, has been simplified for illustration purposes. In practice, a plurality of flow preforms may be required to completely fill annular region 520, thereby multiplying the number of parameters for the preform charge. This in turn enlarges the parameter space exponentially, and may increase the number of possible solutions commensurately.

As an example, the enlarged parameter space might include one or more parameters pertaining to the number of preforms. In some implementations, there might be parameters specifying the number of preforms in each of a plurality of preform categories (e.g., longer/shorter preforms, longer/medium/shorter preforms, flow/non-flow preforms, etc.), while in some other implementations there might be one or more parameters specifying ratios among the categories (e.g., twice as many shorter preforms as longer preforms in the final component, etc.), while in yet other implementations there might be a single parameter specifying the total number of preforms.

Similarly, the enlarged parameter space might comprise parameters pertaining to physical dimensions of the preforms, such as individual lengths for each of the preforms; preform lengths relative to adjacent preform lengths (e.g., flow-preform lengths relative to adjacent flow-preform lengths, non-flow-preform lengths relative to adjacent preform lengths [whether flow or non-flow], etc.); preform lengths for each of a plurality of categories (e.g., a length for longer preforms, a length for shorter preforms, a length for flow preforms, a length for non-flow preforms, etc.); and so forth.

As another example, the enlarged parameter space might include parameters pertaining to the locations of each of the preforms relative to annular region 520 (e.g., Cartesian coordinates of one or both ends of a straight-segment preform, polar coordinates of one or both ends of the preform, an orientation angle, etc.). In some implementations, preform locations might be absolute values, while in some other embodiments the locations might be with respect to a particular feature or region of the component/mold, while in yet other embodiments the location of a preform might be with respect to another preform in the horizontal plane (e.g., an adjacent preform, etc.), and/or in the vertical plane (e.g., the vertical position of a preform in a layup stack, etc.). The values of these parameters are fundamental, as placement of the flow preforms within mold cavity forming component 500 affects the pressure gradient, which in turn affects the forces that the preforms are subjected to, and thus the resultant flow into the cavity corresponding to annular region 520.

It should be noted that constraints governing parameter values can aid in reducing the size of the parameter space. In the present example, such constraints might include one or more of the following:
constraints with respect to the number of preforms (e.g., a maximum number of preforms, a minimum number of preforms, etc.);
constraints with respect to the number of preforms in different categories (e.g., a maximum number of flow preforms, a minimum number of non-flow preforms, a maximum number of shorter-length preforms, a minimum ratio of flow preforms to non-flow platforms, a constraint that there must be fewer shorter preforms than longer preforms, etc.);
constraints with respect to preform lengths (e.g., the combined volume of the flow preforms must be at least as large as the volume of annulus region 520; the lengths of all flow preforms must not exceed one centimeter; the lengths of all non-flow preforms must not exceed two centimeters; the minimum length for both flow and non-flow preforms is 0.2 centimeters, etc.).

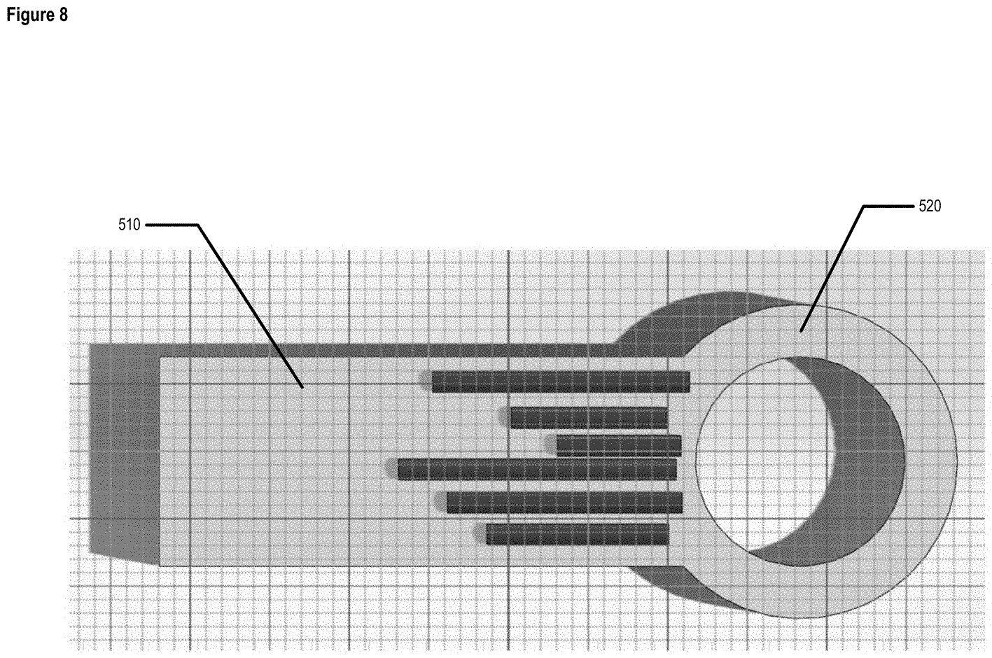

FIG. 8 depicts component 500 with an alternative preform charge, in accordance with one embodiment of the present disclosure. The preform charge in FIG. 8 represents a potential combination of straight-segment flow preforms for filling annular region 520. The view in this figure is the same as that of FIG. 7, with a grid overlaid on top in order to more clearly illustrate the proximal arrangement of the six flow preforms. The grid can serve as a parameterized reference space in which preform arrangements (for both flow and non-flow preforms) are defined using Cartesian coordinates. It should be noted that while the overlay grid in FIG. 8 is planar, this parameterization approach can be used to specify preform placement in three-dimensional space (e.g., within a vertical stack sequence of a preform charge, etc.). In some embodiments, the axis of the vertical dimension is parallel to the axis on which pressure is applied during molding, which may or may not be perpendicular to the horizontal grid plane.

In this particular example, for illustrative purposes, there are six parameters in the parameter space, with each parameter having ten possible values within its respective range. For example, a parameter for the length of a preform might have any of the following ten values: 0.1 cm, 0.2 cm, 0.3 cm, 0.5 cm, 0.67 cm, 0.75 cm, 0.8 cm, 0.85 cm, 0.9 cm, 1.0 cm. This example is merely illustrative, and demonstrates how parameter values can discretize a potentially-continuous parameter, as well as how the parameter values are not required to be uniformly-spaced.

In this particular example, once again for illustrative purposes, the parameters are non-exclusive (i.e., a value for one parameter does not affect the values of the other parameters). Accordingly, the number of states in the parameter space is 10⁶, or one million possible combinations. Even one-tenth of such a parameter space, 100,000, may be considered prohibitive for high-throughput experimentation for a molded part (one-tenth of this number. It should be noted that in some other examples, the number of possible values may differ among parameters (e.g., one parameter might have ten possible values while another parameter might have four possible values, etc.).

The parameter space in this example may be considered modest, as it is possible to discretize continuous variables into a much larger number of possible values. For example, discretizing just one of the parameters by a factor of ten (i.e., 100 possible preform-length values rather than 10) will commensurately increase the parameter space by a factor of ten, from one million to ten million. In some embodiments, the granularity of discretization may be chosen based on one or more factors such as process capability (e.g., the tolerance for creating preform shapes in a particular process might be +/−0.1 mm, etc.), desired resolution of the resultant model, economic considerations (e.g., time constraints for obtaining candidate components via the statistical model, time constraints for testing the candidates, etc.), etc.

As will be appreciated by those skilled in the art, while multiple parameter value combinations within the parameter space may satisfy one or more defined constraints (e.g., adequately filling annulus region 520, etc.), the combinations may differ in their performance due to variations in the resultant components (e.g., fiber orientation, etc.). As each combination possesses a particular consolidation dynamic corresponding to associated fluid dynamics, the resultant component strengths for the various combinations may vary based on differences in fiber alignment in the annulus region 520.

In one embodiment, the candidate components are produced in accordance with the output parameter values of the candidate combinations in the parameter space, and are subsequently tested (e.g., with respect to relevant loading, etc.). As noted above, in the present example a desired loading for component 500 is one in which prismatic region 510 is constrained while annulus region 520 is pulled in tension along an axis parallel to the major axis of prismatic region 510.

In accordance with one embodiment, data obtained from the testing of the candidate components are used to generate a statistical model that accepts one or more component objectives as input (e.g., maximizing the strength of annulus region 520, etc.), and that generates parameter values intended to optimize, or come close to optimizing, the objective(s). When the parameter combination sampling and associated testing are done intelligently, the statistical model is capable of generating parameter values that have a high probability of producing a component with desired (and ideally optimal) output characteristics, as per the given component objective(s).

FIGS. 9A, 9B, and 9C depict a flow diagram of aspects of a method 900 for determining input parameter values for the production of a compression-molded component, in accordance with one or more embodiments of the present disclosure. The method may be performed by processing logic that may comprise hardware (circuitry, dedicated logic, etc.), software (such as is run on a general-purpose computer system or a dedicated machine), or a combination of both. In some embodiments, blocks depicted in FIGS. 9A, 9B, and 9C might be performed concurrently, or in a different order than that depicted.

At block 901, one or more objectives are defined for producing a component with desired characteristics. In some examples, an objective may be an optimization objective, such as:
maximizing the strength of the component;
maximizing strength in a particular region of the component;
maximizing the stiffness of the component;
maximizing stiffness in a particular region of the component;
minimizing the number of preforms;
minimizing the combined volume of flow preforms (given the constraint that the this volume must be at least as large as the total volume of the void spaces in the associated mold);
maximizing thermal stability;
maximizing impact resistance;
minimizing cost;
maximizing RF transparency;
maximizing surface finish aesthetic quality and/or consistency.

In some examples, one or more constraints may also be defined, such as:
the strength of the component meeting or exceeding a threshold;
strength in a particular region of the component meeting or exceeding a threshold;
the stiffness of the component meeting or exceeding a threshold;
stiffness in a particular region of the component meeting or exceeding a threshold;
the number of preforms being less than a threshold;
the number of preforms being exactly equal to a desired value;
the preform stack height being less than a threshold;
the preform stack height being exactly equal to a desired value;
the number of bends in a particular preform being less than a threshold;
the number of bends in a particular preform being exactly equal to a desired value.

At block 902, a parameter space is defined. In one embodiment, this process comprises defining all parameters that can have more than one value, and defining the possible range of values for each parameter. The parameter space is then the entirety of all parameters across their respective ranges.

At block 903, the parameter space is narrowed. In one embodiment, the size of the narrowed parameter space may be determined by estimating the amount of data required to develop a representative statistical model of the initially-narrowed parameter space. This estimate may be based on measures such as the number of features to test, the ranges of the features to test, etc. In some implementations, the narrowing of the parameter space may include applying one or more constraints (e.g., one or more of the constraints defined at block 901, etc.). An example implementation of block 903 is described in detail below with respect to FIG. 10.

At block 904, a dataset is generated from which a statistical model will be derived. In one implementation, the dataset is generated by randomly sampling the narrowed parameter space to obtain combinations of parameter values (e.g., parameter values pertaining to preform shape, preform-charge layup sequence, pressure trend, etc.). The random sampling, which represents a further narrowed set of experimentation data within the parameter space, can be used to guide automated manufacture of various possible manifestations of the desired component (e.g., at block 908 below, etc.). In some implementations, the random sampling begins in regions of the sampling space observed to produce better results, while in some other implementations the random sampling begins with an uninformed or arbitrarily-selected initial condition.

In one embodiment, the random sampling is performed in an automated fashion. In one implementation, the random sampling is performed by an automated cell, which is an automated apparatus that is capable of converting raw material into components and testing the components to gather data. In one such example, the automated cell comprises a process-control computer that does the random sampling and data gathering, and may perform other data-processing functions such as generating the dataset at block 904 above, and/or generating the statistical model at block 905 below, etc. In accordance with this implementation, the automated cell is constructed, and a logging structure for the cell is subsequently enabled. In one example, the logging structure logs all of the input parameter values used to manufacture the components at block 908 below.

In another implementation, the random sampling may be performed by a human (e.g., a data scientist, etc.). In still other implementations, a combination of the above approaches may be employed (i.e., an automated apparatus performing the random sampling under the guidance of a human [e.g., based on engineering knowledge, etc.]).

At block 905, one or more candidate components are manufactured via a compression-molding process, where each candidate component corresponds to a respective parameter value combination in the narrowed parameter space. In one embodiment, for a given candidate component, one or more preforms conforming to the respective parameter value combination are produced, and the produced preforms are placed in either a mold or a fixture (as described below) in conformance with the respective parameter value combination. In one implementation, a preform charge is formed from a plurality of preforms, and the preform charge is placed directly in a mold. In another implementation, the preforms are placed on a fixture, a preform charge is then formed on the fixture, and the fixture is placed in a mold.

At block 906, the candidate component(s) manufactured at block 905 are tested (e.g., with respect to the objective, with respect to one or more other characteristics, etc.).

At block 907, a statistical model is generated based on the dataset. As noted above, a statistical model is a set of one or more statistical assumptions that enable calculation of outcome probabilities. In the present method, an outcome is a set of values for parameters in the parameter space.

In one implementation, the statistical model is specified via one or more mathematical equations, where one or more of the variables of the equation(s) have associated probability distributions rather than specific values (i.e., one or more of the variables are stochastic). In one aspect, inputs to the statistical model include the component objective(s) defined at block 901, and outputs from the model include parameter values intended to optimize, or come close to optimizing, the given objective(s). The model thus correlates input data to output data probabilistically, which can potentially provide and/or enhance predictive capability. In some examples, the predictive capability may apply to phenomena that were thought in the prior art to be unpredictable.

At block 908, the statistical model is applied to the narrowed parameter space. At block 909, the accuracy of the statistical model is estimated. In one implementation, accuracy is estimated based on the model output of block 908 and the test results from block 906. Block 910 then branches based on whether the model is sufficiently accurate. If the model is sufficiently accurate, execution of the method proceeds to block 919. Otherwise, execution continues at block 911.

At block 911, a set of potentially-promising parameter value combination(s) is identified based on one or more outputs of the statistical model. At block 912, the statistical model is updated based on this set (e.g., by adding this set to the statistical model, etc.), and at block 913, the narrowed parameter space is further narrowed in view of this set.

At block 914, one or more candidate components are manufactured, where each candidate component corresponds to a respective parameter value combination in the further-narrowed parameter space. At block 915, the candidate component(s) are tested (e.g., with respect to the objective, with respect to one or more other characteristics, etc.).

At block 916, the statistical model is applied to the further-narrowed parameter space. At block 917, the accuracy of the updated statistical model is estimated. In one implementation, accuracy is estimated based on the model output of block 908 and the test results from block 906. Block 918 then branches based on whether the updated model is sufficiently accurate. If the model is sufficiently accurate, execution of the method proceeds to block 919. Otherwise, execution continues back at block 911.

At block 919, a parameter value combination is selected based on the model output (i.e., output of the updated model if block 919 was preceded by block 918, or output of the original model if block 919 was preceded by block 910). In particular, a combination is selected that yields the best result, where “best result” means that the component produced by the selected combination optimizes, or comes closest to optimizing, the objective(s) defined at block 901.

At block 920, a component is manufactured, via the compression molding process, using the parameter value combination selected at block 919. After block 920 has completed, method 900 terminates.

FIG. 10 depicts a flow diagram of aspects of a method for narrowing a parameter space to be used for generating a statistical model, in accordance with one embodiment of the present disclosure. In one example, the method is used to implement block 903 and/or block 904 above. The method may be performed by processing logic that may comprise hardware (circuitry, dedicated logic, etc.), software (such as is run on a general-purpose computer system or a dedicated machine), or a combination of both. In some embodiments, blocks depicted in FIG. 10 might be performed concurrently, or in a different order than that depicted.

At block 1001, engineering principles and/or model(s) are applied (e.g., to determine constraint(s), threshold(s), discretization granularity, etc.). At block 1002, statistical sampling method(s) are applied; such methods define a portion of data that is intended to be representative of the whole.

At block 1003, statistical methods are applied to inform the size of the dataset defined below in block 1004. In one embodiment, the size of the dataset may be based on measures such as the number of features to test, the ranges of the features to test, etc.

At block 1004, an adequately-sized and adequately-sampled dataset is defined. In one embodiment, the size may be further informed by a model of complexity that captures, for example, the complexity of the objective, the number of objectives, etc. After block 1004 has completed, method 1000 terminates.

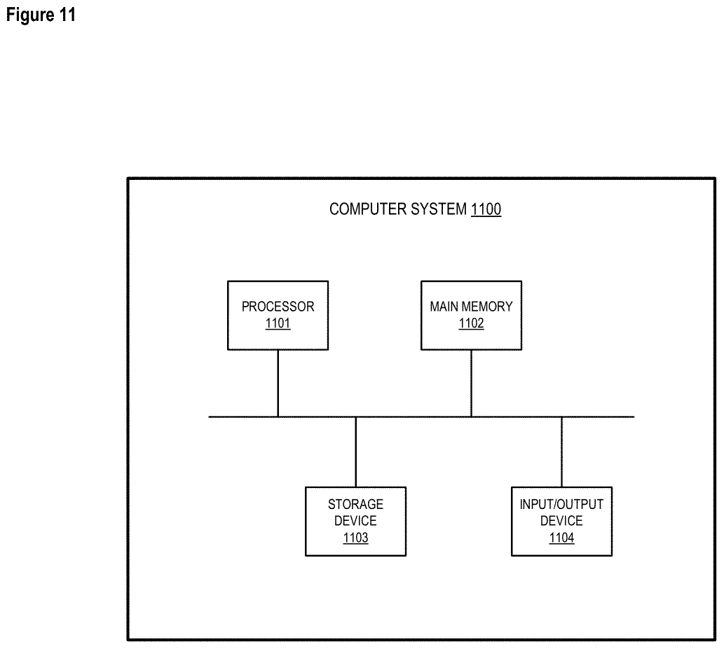

FIG. 11 depicts a block diagram of an illustrative computer system 1100 operating in accordance with aspects and implementations of the present disclosure. Computer system 1100 may be a personal computer (PC), a laptop computer, a tablet computer, a smartphone, or any other computing or communication device. As shown in FIG. 11 , computer system 1100 comprises processor 1101, main memory 1102, storage device 1103, and input/output (I/O) device 1104, interconnected as shown (e.g., via one or more busses, etc.).

Processor 1101 represents one or more general-purpose processing devices such as a microprocessor, central processing unit, or the like. More particularly, processor 1101 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. Processor 1101 may also be one or more special-purpose processing devices such as an application specific integrated circuit (ASIC), a field programmable gate array (FPGA), a digital signal processor (DSP), network processor, or the like. Processor 1101 is capable of executing instructions stored in main memory 1102 and storage device 1103, including instructions corresponding to the method of FIG. 1 above; of reading data from and writing data into main memory 1102 and storage device 1103; and of receiving input signals and transmitting output signals to input/output device 1104. While a single processor is depicted in FIG. 11 for simplicity, computer system 1100 might comprise a plurality of processors.

Main memory 1102 is capable of storing executable instructions and data, including instructions and data corresponding to the method of FIG. 1 above, and may include volatile memory devices (e.g., random access memory [RAM]), non-volatile memory devices (e.g., flash memory), and/or other types of memory devices.

Storage device 1103 is capable of persistent storage of executable instructions and data, including instructions and data corresponding to the method of FIG. 1 above, and may include a magnetic hard disk, a Universal Serial Bus [USB] solid state drive, a Redundant Array of Independent Disks [RAID] system, a network attached storage [NAS] array, etc. While a single storage device is depicted in FIG. 11 for simplicity, computer system 1100 might comprise a plurality of storage devices.

I/O device 1104 receives input signals from a user of computer system 1100, forwards corresponding signals to processor 1101, receives signals from processor 1101, and emits corresponding output signals that can be sensed by the user. The input mechanism of I/O device 1104 might be an alphanumeric input device (e.g., a keyboard, etc.), a touchscreen, a cursor control device (e.g., a mouse, a trackball, etc.), a microphone, etc., and the output mechanism of I/O device 1104 might be a liquid-crystal display (LCD), a cathode ray tube (CRT), a speaker, etc. While a single I/O device is depicted in FIG. 11 for simplicity, computer system 1100 might comprise a plurality of I/O devices.

It is to be understood that the above-described embodiments are merely illustrative, and that many variations of the above-described embodiments can be devised by those skilled in the art without departing from the scope of this disclosure. It is therefore intended that such variations be included within the scope of the following claims and their equivalents.

1. A method for producing a compression-molded component, comprising:
defining a parameter space comprising a set of values of a parameter, wherein the parameter corresponds to a property of fiber bundles, and wherein the set of values represents all possible values of the parameter in the parameter space;
narrowing the parameter space to obtain a narrowed parameter space, wherein the narrowed parameter space comprises a first proper subset of the set of values of the parameter, and wherein the first proper subset represents all possible values of the parameter in the narrowed parameter space;
generating a statistical model based on a sampling of the narrowed parameter space;
applying the statistical model to the narrowed parameter space to obtain a first set of outputs;
identifying a set of one or more parameter value combinations based on the first set of outputs;
updating the statistical model based on the identified one or more parameter value combinations;
further narrowing, based on the first set of outputs, the parameter space to obtain a further-narrowed parameter space, wherein the further-narrowed parameter space comprises a second proper subset of the first proper subset, the second proper subset containing the identified one or more parameter value combinations and representing all possible values of the parameter in the further-narrowed parameter space;
applying the updated statistical model to the further-narrowed parameter space to obtain a second set of outputs;
selecting from the further-narrowed parameter space, based on the second set of outputs, a value of the parameter;
producing a bundle of fibers conforming to the selected value of the parameter; and
manufacturing a component comprising the bundle of fibers using a compression-molding process.

2. The method of claim 1 wherein the property of fiber bundles is length.

3. The method of claim 1 wherein the selecting is further based on an objective for the component.

4. The method of claim 3 wherein the objective is maximum strength.

5. The method of claim 1 wherein the further narrowing is based on testing a candidate component that is manufactured based on the first set of outputs.

6. The method of claim 5 wherein the objective is closer to optimal in the manufactured component than in the candidate component.

7. A method for producing a compression-molded component, comprising:
defining a parameter space comprising a set of values of a parameter, wherein the parameter corresponds to a property of fiber bundles, and wherein the set of values represents all possible values of the parameter in the parameter space;
narrowing the parameter space to obtain a narrowed parameter space, wherein the narrowed parameter space comprises a proper subset of the set of values of the parameter, and wherein the proper subset represents all possible values of the parameter in the narrowed parameter space;
generating a statistical model based on a sampling of the narrowed parameter space;
selecting from the proper subset, based on the statistical model, a value of the parameter;
producing a bundle of fibers conforming to the selected value of the parameter; and
manufacturing a component comprising the bundle of fibers using a compression-molding process.

8. The method of claim 7 wherein the property of fiber bundles is fiber alignment.

9. The method of claim 7 wherein the narrowing is based on an objective for the component.

10. The method of claim 9 wherein the objective is maximum stiffness.

11. A method for producing a compression-molded component, the method comprising:
defining a parameter space comprising a set of values of a parameter, wherein the parameter corresponds to a property of fiber bundle placements in compression molding, and wherein the set of values represents all possible values of the parameter in the parameter space;
narrowing the parameter space to obtain a narrowed parameter space, wherein the narrowed parameter space comprises a proper subset of the set of values of the parameter, and wherein the proper subset represents all possible values of the parameter in the narrowed parameter space;
generating a statistical model based on a sampling of the narrowed parameter space;
selecting from the proper subset, based on the statistical model, a value of the parameter;
placing a bundle of fibers in a mold, the placement conforming to the selected value of the parameter; and
manufacturing a component using the mold and a compression-molding process.

12. The method of claim 11 wherein the property of fiber bundle placements is location.

13. The method of claim 12 wherein the location is relative to another fiber bundle in the mold.

14. The method of claim 12 wherein the location is relative to a feature of the mold.

15. The method of claim 12 wherein the bundle of fibers is in a stack comprising an additional fiber bundle, and wherein the location comprises a vertical height.

16. The method of claim 12 wherein the selecting is further based on an objective for the component.

17. A method for producing a compression-molded component, the method comprising:
defining a parameter space comprising a set of values of a parameter, wherein the parameter corresponds to a property of fiber bundle placements in compression molding, and wherein the set of values represents all possible values of the parameter in the parameter space;
narrowing the parameter space to obtain a narrowed parameter space, wherein the narrowed parameter space comprises a proper subset of the set of values of the parameter, and wherein the proper subset represents all possible values of the parameter in the narrowed parameter space;
generating a statistical model based on a sampling of the narrowed parameter space;
selecting from the proper subset, based on the statistical model, a value of the parameter;
placing a bundle of fibers in a fixture, the placement conforming to the selected value of the parameter;
placing one or more additional fiber bundles in the fixture;
forming, in the fixture, an assemblage of preforms from the bundle of fibers and the one or more additional fiber bundles, the forming comprising at least one of bonding or tacking;
placing the fixture in a mold; and
manufacturing a component using the mold and a compression-molding process.

18. The method of claim 17 wherein the property of fiber bundle placements is orientation.

19. The method of claim 17 wherein the narrowing is based on an objective for the component.

20. The method of claim 19 wherein the objective is thermal stability.

21. (canceled)

22. The method of claim 17 wherein the property of fiber bundles is a number of bends.

23. The method of claim 17 wherein the selecting is further based on an objective for the component.

24. The method of claim 23 wherein the objective is maximum impact resistance.
